(19) United States
(12) Patent Application Publication
(10) Pub. No.: US 2004/0082706 A1
(43) Pub. Date: Apr. 29, 2004

(54) Water resistant polyvinyl acetate aqueous emulsion for applying to wood material

(75) Inventors: Jing-Jin Tsai, Miaoli (TW); Li-Shing Lin, Miaoli (TW); Gan-Dar Fan, Miaoli (JP)

Correspondence Address: BACON & THOMAS, PLLC, 625 SLATERS LANE, FOURTH FLOOR, ALEXANDRIA, VA, 22314

(73) Assignee: CHANG CHUN PETROCHEMICAL CO., LTD., Taipei (TW)

(21) Appl. No.: 10/606,902

(22) Filed: Jun. 27, 2003

(30) Foreign Application Priority Data
Oct. 24, 2002 (TW) 091124724

(51) Int. Cl. C08J 3/00

(52) U.S. Cl. 524/503

(57) ABSTRACT

The present invention relates to a water resistant polyvinyl acetate aqueous emulsion, which is useful as an adhesive for applying to wood material. The present polyvinyl acetate aqueous emulsion is free of formalin and exhibits excellent water resistance.

The polyvinyl acetate aqueous emulsion of the present invention can be either used alone or combined with additional cross-linking agent to further improve the water resistance. Also, when the polyvinyl acetate aqueous emulsion of the present invention is used to make plywood, the later can satisfy second type plywood standard regulated in CNS1349.

### FIELD OF THE INVENTION

The present invention relates to a water resistant polyvinyl acetate aqueous emulsion, which is useful as an adhesive for applying to wood material. The present polyvinyl acetate aqueous emulsion is free of formalin and exhibits excellent water resistance.

### BACKGROUND OF THE INVENTION

In manufacture of plywood and furniture, wood gluing agent is generally based on urea resin. However, it is potentially dangerous to use the urea resin as wood gluing agent, as it will release formalin during processing. The urea resin used as plywood gluing agent will gradually be affected by acid material and water contained in wood and affected by moisture atmosphere, which is in turn aged and degraded to form and release free formalin. Such free formalin is harmful to human being (Wood Adhesive In 1985: Status and Needs). Therefore, how to decrease free formalin in urea resin becomes important. Unfortunately, no resolution is successfully proposed till now.

Although polyvinyl acetate resin has been widely used for bonding wood and its processing, a water resistance and a heat resistance of the polyvinyl acetate are insufficient so that it is not suitable for plywood and the circumstance where a water resistance is required. Therefore, it is important to improve the water and heat resistance of polyvinyl acetate. Armour et al., in U.S. Pat. No. 3,563,851 disclosed a method for increasing water resistance by co-polymerizing vinyl acetate and acrylates then heating and curing in the presence of acidic metal salt as a curing agent.

The curing mechanism of polyvinyl acetate is different from the curing mechanism of condensing type resin. Polyvinyl acetate emulsion has relatively high polymerization degree so that in curing process its molecule chain would not continue to polymerize but only evaporate aqueous solvent to form a film. After applying polyvinyl acetate emulsion, the distance between emulsion particle become closer due to evaporation of water contained therein. When water is evaporated completely, the particles are fused each other to become a transparent film. Such a curing mechanism allows the adhesive attaining its maximum adhesive strength. Its curing rate is faster than condensation rate at ambient temperature (see, e.g. Okizu, T1956).

The free formalin associated with urea resin type adhesive is problematic at present. While although the free formalin problem is overcome by using isocyanate resin type adhesive, it has not widely used in the field due to high cost of the isocyanate resin type adhesive.

Based on the above disadvantages, the present inventors have conducted an investigation on the property of polyvinyl acetate emulsion and therefore completed the present invention.

### OBJECTS OF THE INVENTION

One object of the present invention is to provide a water resistant polyvinyl aqueous acetate emulsion, which is useful as an adhesive for applying to wood material. The polyvinyl acetate aqueous emulsion is free of formalin and exhibits excellent water resistance.

The polyvinyl acetate aqueous emulsion of the present invention can be either used alone or combined with additional cross-linking agent to further improve the water resistance. Also, when the polyvinyl acetate aqueous emulsion of the present invention is used to make plywood, the resultant plywood can satisfy second type plywood standard regulated in CNS1349.

### DETAILED DESCRIPTION OF THE INVENTION

The water resistant polyvinyl acetate emulsion used as a wood adhesive according to the present invention comprises the polyvinyl acetate copolymer of the following formula (I) as main ingredient:

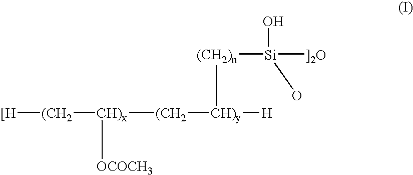

wherein:

n represents an integer of from 0 to 5;

a ratio of x/y is from 4 to 1000, preferably from 4 to 190, most preferably 15 to 190;

a molecular weight of the polyvinyl acetate copolymer is from 1,000 to 800,000, preferably from 50,000 to 600,000, most preferably from 10,000 to 500,000.

The x repeating units of —(CH₂—CH(OCOCH₃)—) and y repeating units of —(CH₂—CH)—in the formula (I) are either random polymerized or block polymerized or a combination thereof.

The water resistant polyvinyl acetate aqueous emulsion used as a wood adhesive according to the present invention (hereinafter sometimes simply refer to polyvinyl acetate) is free of formalin without a problem of release of formaldehyde and possesses an excellent adhesion for bonding wood. Therefore it is advantage to use as gluing agent for plywood and wooden ware. The water resistant polyvinyl acetate emulsion used as a wood adhesive according to the present invention can be either used alone or combined with additional cross-linking agent or cross-linking type adhesive to further improve the bonding strength.

The present invention also provides a method for producing the polyvinyl acetate (I) contained in the present polyvinyl acetate aqueous emulsion, which comprises reacting vinyl acetate with silicon monomer containing ethylenically unsaturated functional group represented by the following formula (II) in the presence of catalyst in aqueous medium at an atmosphere pressure:

CH₂═CH—(CH₂)ₙ—Si(R¹)ₘ(R²)₃₋ₘ (II)

wherein

R¹=C₁₋₆ alkyl group;

R²=C₁₋₄₀ alkoxy group, preferably C₁₋₁₂ alkoxy group;

n=0 to 5;

m=0 to 3.

In the above method, the silicon monomer containing ethylenically unsaturated functional group is 0.01 to 15%, preferably 0.5 to 3% based on the total weight of vinyl acetate and the silicon monomer. The reaction is conducted at a temperature of from 55 to 90° C., preferably from 60 to 80° C., at an atmosphere pressure for 4 to 8 hours. After the reaction is completed, the resultant mixture is cured at a temperature of from 65 to 95° C., preferably from 70 to 90° C., for 2 to 3 hours.

The terms “C₁₋₆ alkyl group” and “C₁₋₄₀ alkoxy group” used herein include a straight and branched one.

The catalyst used in the present method can be peroxide, for example, persulfate such as ammonium persulfate, sodium persulfate, potassium persulate, hydrogen peroxide, benzoyl peroxide, permanganate, and the like.

The aqueous medium used in the present method can be any aqueous medium, as long as it does not interfere with the proceeding of the reaction.

Examples of the silicon monomer containing ethylenically unsaturated functional group include, for example, but not limited to, vinyltrimethoxysilane, vinyltriethoxysilane, vinyltriisopropoxysilane, vinylmethyldimethoxysilane, vinyltributoxysilane, vinylethyldipropoxysilane, vinyltripentoxysilane, vinyltrihexyloxysilane, and the like.

The following schemes A and B further illustrate reaction of the water resistant polyvinyl acetate aqueous emulsion:

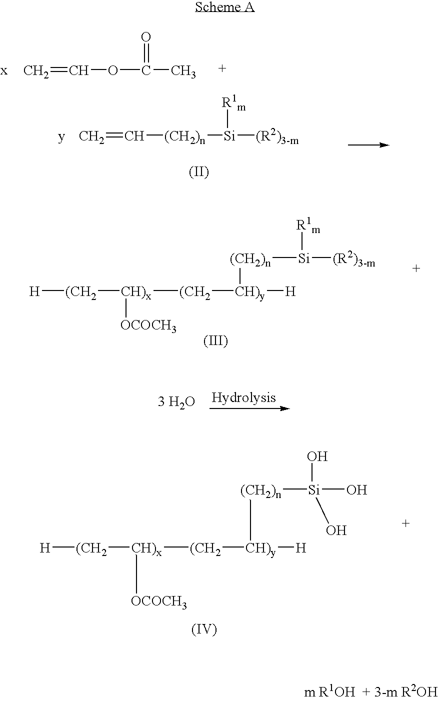

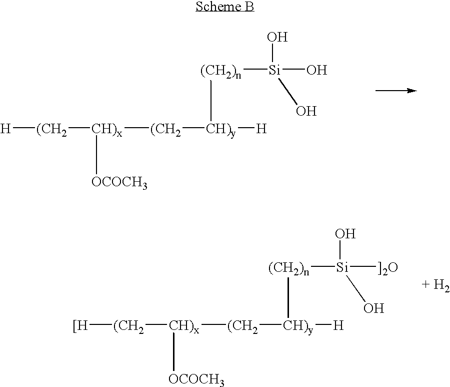

According to the above Schemes, it is known that vinyl acetate is copolymerized with silicon monomer containing ethylenically unsaturated functional group to form a silicon-containing polyvinyl acetate copolymer of formula (III). The copolymer (III) is then hydrolyzed in the presence of water to form a silicon- and hydroxy-containing polyvinyl acetate copolymer of formula (IV). The silicon- and hydroxy-containing polyvinyl acetate copolymer of formula (IV) is then self cross-linked after evaporation of water to form the present polyvinyl acetate of formula (I) which is water resistant. In other words, the emulsion of the present invention is the emulsion of the silicon- and hydroxy-containing polyvinyl acetate copolymer of formula (IV) in aqueous medium, which is water resistant when it is applied on wooden substrates as gluing agent and dried.

Further, from the Scheme B it is known that although the copolymer (III) is hydrolyzed to form copolymer (IV) in the presence of water, the copolymer would not be self cross-linked due to the presence of water. Therefore, the polyvinyl acetate aqueous emulsion of the present invention has long operation time and shelf time. The polyvinyl acetate aqueous emulsion of the present invention will be self cross-linked after evaporation of water without adding of other metal catalyst nor heating. Moreover, a bonding will be formed between the hydroxy group contained in the copolymer (IV) and a hydrophilic portion of substrate to be bonded such as wooden substrate to further improve the adhesive strength between them. If the polyvinyl acetate aqueous emulsion of the present invention is used as a composition combined with other cross-linking type adhesive (such as urea resin, isocyanate resin etc.,) to bonding plywood, a water resistance will be further improved. When the polyvinyl acetate aqueous emulsion of the present invention is used as a composition combined with other cross-linking type adhesive, the polyvinyl acetate aqueous emulsion of the present invention is used in an amount of from 5 to 95.5% by weight of the composition.

The polyvinyl acetate aqueous emulsion of the present invention has a long operation time. It would not be cured due to its long shelf time of 8 hours or more. Thus, there is no curing problem in short time when operation.

The present invention will further be explained through the following Examples. However, it should be understood by those skilled in the art that the Examples are only used to illustrate the present invention without limiting the scope of the present invention.

### EXAMPLE 1

In emulsion polymerization reactor an aqueous solution of 10% polyvinyl alcohol (980 grams) having a degree of polymerization (DP) of 1700 was prepared at atmosphere pressure. In a separate reactor an aqueous solution of 8-10% ammonium persulfate (50 grams) was prepared. Also, a monomer mixture of 900 grams of vinyl acetate monomer and 60 grams of vinyltrimethoxysilane was prepared. The aqueous solution of 10% polyvinyl alcohol (980 grams) was heated to 80° C. in the emulsion polymerization reactor and then 20 grams of the ammonium persulfate solution was added into thereto. The resultant mixture was stirred to form a uniform mixture. The above monomer mixture and 20 grams of the ammonium persulfate solution were added dropwise to the uniform mixture in rates of 3 ml/min and 0.07 g/min, respectively. The reaction was carried out at a temperature of 80° C. for 5 hours. After the reaction is completed, the temperature of the reaction mixture was raised to 90° C., the remaining ammonium persulfate solution was then added to the reaction mixture and cured for 1.5 hours. After aging, the resultant mixture was allowed to room temperature to obtain the emulsion of the silicon- and hydroxy-containing polyvinyl acetate copolymer of formula (IV) in aqueous medium of the present invention.

The emulsion of the silicon- and hydroxy-containing polyvinyl acetate copolymer of formula (IV) in aqueous medium of the present invention was tested its viscosity, solid content, and pH value according to the methods of JIS-K6828. Moreover, a rigid film produced by drying and cross-linking the emulsion was tested its water resistance according to EN204. The data was compared with a commercial product B (a polyvinyl acetate emulsion sold by Chang Chun Petrochemical Co., Ltd. under catalog number AE-150) and the result is shown in the following Table 1.

### EXAMPLE 2

An emulsion of the silicon- and hydroxy-containing polyvinyl acetate copolymer of formula (IV) in aqueous medium of the present invention was produced according to the method of Example 1, except substituting vinyltriisopropoxysilane for vinyltrimethoxysilane. The resultant emulsion was tested its various properties according the methods mentioned in Example 1 and its result was also shown in Table 1.

TABLE 1

| | | | | Order of water |
|---|---|---|---|---|
| | Viscosity | Solid content | pH value | resistance |
| Example 1 | 15,000 cps | 52% | 5.1 | >D3 |
| Example 2 | 13,000 cps | 52.2% | 4.9 | >D3 |
| Commercial | 11,400 cps | 50.2% | 5.0 | >D2 |
| product B | | | | |

### EXAMPLE 3-6

Emulsions of the silicon- and hydroxy-containing polyvinyl acetate copolymer of formula (IV) in aqueous medium of the present invention was produced according to the method of Example 1, except substituting vinyltriisopropoxysilane for vinyltrimethoxysilane and the weight ratio of vinyl acetate monomer/ vinyltriisopropoxysilane monomer was changed to 924/40, 884/80, 864/110, and 824/140 respectively in Examples 3 to 6. The resultant emulsions were tested their various properties according the methods mentioned in Example 1 and its result was also shown in Table 2.

TABLE 2

| | | | | Order of water |
|---|---|---|---|---|
| | Viscosity | Solid content | pH value | resistance |
| Example 3 | 11,000 cps | 52.2% | 4.9 | >D3 |
| Example 4 | 12,400 cps | 51.2% | 5.0 | >D3 |
| Example 5 | 15,000 cps | 51.6% | 4.8 | >D3 |
| Example 6 | 14,000 cps | 51.8% | 4.8 | >D3 |

### Experiment Example 1

The emulsion produced from Example 1, a commercial product A (a polyvinyl acetate emulsion sold by Chang Chun Petrochemical Co., Ltd. under catalog number AE-950), and a commercial product B (a polyvinyl acetate emulsion sold by Chang Chun Petrochemical Co., Ltd. under catalog number AE-150) were each applied on plywoods at an amount of 10 grams/m². The plywoods applied with the same emulsion were pressed together at a pressure of 1 kg/cm² and a temperature of 110° C. for 15 to 48 hours, and then back to ambient temperature, according to the method of CNS 1349. The plywoods were then tested its peeling length and gluing shear force after impregnating in water, according to the method of CNS 1349 concerning the second type plywood. The results are shown in Table 3.

TABLE 3

| | | Commercial | Commercial |
|---|---|---|---|
| | | product | product |
| Adhesive | Example 1 | A | B |
| Peeling strength | 0 | 15 | 26 |
| after impregnating in | | | |
| water (mm)* | | | |
| Gluing shear force | 7.2 | 1.5 | 0.5 |
| (kgf/cm²)** | | | |
| Assessment | Pass | Fail | Fail |

Note:
*Peeling strength after impregnating in water: The plywood sheet sample was impregnated in water at 70° C. for 2 hours, then dried at 60° C. for 3 hours, and then tested its peeling strength according to the method of CNS 1349. It is passed if peeling length is 25 mm or less.
**Gluing shear force: The plywood sheet sample was impregnated in water at 60° C. for 3 hours then back to ambient temperature. The plywood sheet sample was tested its pulling strength in wet state according to the method of CNS 1349. It is passed if the strength is 6 kgf/cm² or more.

### Experiment Example 2

The emulsion produced from Example 1 was mixed with isocyanate resin type adhesive in a weight ratio of 85:15 to give a composition A. Separately, the emulsion produced from Example 1 was mixed with urea resin type adhesive in a weight ratio of 85:15 to give a composition B. The emulsion produced from Example 1 alone, composition A, composition B, and the urea resin type adhesive alone were each tested its peeling length and gluing shear force after impregnating in water according to the method of Experiment Example 2. The results are shown in Table 4.

TABLE 4

| | | Composition | Composition | Urea resin |
|---|---|---|---|---|
| Adhesive | Example 1 | A | B | type adhesive |
| Peeling | 0 | 0 | 0 | 0 |
| strength after | | | | |
| impregnating in | | | | |
| water (mm)* | | | | |
| Gluing shear | 7.2 | 7.6 | 9.5 | 8.5 |
| force | | | | |
| (kgf/cm²)** | | | | |
| Assessment | Pass | Fail | Fail | Fail |

Note:
*and **are defined as the same as Table 3.

From the above results, it is known that the water resistant polyvinyl acetate aqueous emulsion exhibits excellent bonding strength and excellent water resistance when used as an adhesive for wood material.

What is claimed is:

1. A polyvinyl acetate aqueous emulsion used as adhesive for wood material, wherein the polyvinyl acetate is a copolymer of the following formula (I): 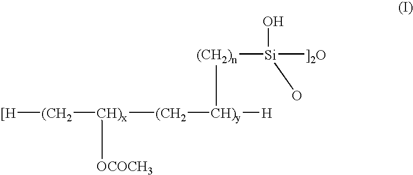
wherein:
n represents an integer of from 0 to 5;
a ratio of x/y is from 4 to 1000;
a molecular weight of the polyvinyl acetate copolymer is from 1,000 to 800,000.

2. The polyvinyl acetate aqueous emulsion according to claim 1, wherein the ratio of x/y is from 4 to 190.

3. The polyvinyl acetate aqueous emulsion according to claim 1, wherein the ratio of x/y is from 15 to 190.

4. The polyvinyl acetate aqueous emulsion according to claim 1, which is further useful for combining with isocyanate resin type adhesive.

5. The polyvinyl acetate aqueous emulsion according to claim 1, which is further useful for combining with isocyanate resin type adhesive.

6. The polyvinyl acetate aqueous emulsion according to claim 1, which is produced by reacting vinyl acetate with silicon monomer containing ethylenically unsaturated functional group represented by the following formula (II):
CH₂═CH—(CH₂)ₙ—Si(R¹)ₘ(R²)₃₋ₘ (II)
wherein
R¹=C₁₋₆ alkyl group;
R²=C₁₋₄₀ alkoxy group, preferably C₁₋₁₂ alkoxy group;
n=0 to 5;
m=0 to 3.
